(19) United States
(12) Patent Application Publication
(10) Pub. No.: US 2017/0132628 A1
(43) Pub. Date: May 11, 2017

(54) ORDER CANCELLATION PROCESSING SYSTEM, PROCESSING METHOD AND BUSINESS SUPPORT SYSTEM

(71) Applicant: Leauto Intelligent Technology (BEIJING) Co. Ltd, Chaoyang District Beijing (CN)

(72) Inventor: Zhao ZHANG, Chaoyang District Beijing (CN)

(21) Appl. No.: 14/976,516

(22) Filed: Dec. 21, 2015

(30) Foreign Application Priority Data
Nov. 11, 2015 (CN) 201510765357.3

(51) Int. Cl. G06Q 20/40; H04L 29/08

(52) U.S. Cl. CPC G06Q 20/407; H04L 67/2842; H04L 67/12

(57) ABSTRACT

The present disclosure discloses an order cancellation processing system, processing method and a business support platform. The method includes: when receiving a user ordering command, analyzing and processing order data uploaded by a user, storing the data in a first storage area and a second storage area respectively; if receiving a user cancellation command, judging whether the order is within a preset time period after placing the order and whether the order is cancelable, if both yes, updating, by the first storage area, then sending the data to the second storage area, and receiving, by the second storage area, the user cancellation command and the data sent by the first storage area, updating the order state to cancellation; sending a command to a bank terminal to change an account; and feeding back order cancellation completion to the user. Thus orders can be cancelled quickly and conveniently.

### CROSS-REFERENCE TO RELATED APPLICATIONS

The present disclosure is based upon and claims priority to Chinese Patent Application No. 201510765357.3, filed on Nov. 11, 2015, the entire contents of which are incorporated herein by reference.

### FIELD OF TECHNOLOGY

The present disclosure relates to a data processing system and processing method, and particularly relates to an order cancellation processing system, processing method and a business support system.

### BACKGROUND

An order is defined as an ordering credential (including an entire procurement process of finished products, raw materials, fuel, parts and components, office supplies, services and the like) provided by an enterprise purchasing department to a supplier in a written form. In the present disclosure, the order just refers to reference of a series of activities used for circulating customer ordering data in an APP or a background business support system (BSS) in the internet industry, and the activities include ordering, payment, cancellation and other related activities.

The BSS system is mainly composed of a network management part, a system management part, a billing part, an operation part, an accounting part and a customer service part, and systems are organically integrated together by a uniform information bus. It can not only help suppliers to develop specific operation support systems suitable for themselves and help to determine the development directions of the systems, as well as help the users to develop the integration standard of the systems and perfect and improve the user service level.

So far, orders based on the internet industry cannot be immediately canceled, they can be canceled only when customers click refund operations, the refund operation substantially refers to cancel the orders and return related amounts into the accounts of the customers in the same way. However, this operation requires manual participation to judge whether ordered goods (virtual or real goods) have been consumed, in order to confirm whether to give a user a refund, the process is slow, and the system is set to a cancellation mode, thus affecting customer experience and customer perception.

The existing order processing mechanism is that the customers place orders at clients, order data are interacted in the BSS system, the transactions of the customers are completed relative to variations of goods, inventories and services together with payments of the customers, the orders are filed and are stored in a historical order list of a database.

If the customers regret after the purchase or make wrong purchases due to wrong operations, the customers can only apply for refunding operation through service personnel or the clients, and it generally needs 3-5 workdays to cancel the orders of the customers and return money to payment accounts of the customers.

### SUMMARY

To solve the above problems, the present disclosure provides an order cancellation processing system and processing method, which store order data in two storage manners, and a business support system.

The present disclosure adopts the following technical solution:

On one aspect, an order cancellation processing method is provided. The method includes the following steps:

when receiving a user ordering command, analyzing and processing order data uploaded by a user, storing data needing to be deleted during cancellation in the order data in a first storage area, and storing data needing to be retained during cancellation in the order data in a second storage area;

if receiving a user cancellation command, judging whether the order is within a preset time period after placing the order and whether the order is cancelable, if both yes, updating, by the first storage area, the data stored when placing the order, sending the data to the second storage area and deleting the data stored when placing the order, and receiving, by the second storage area, the user cancellation command and the data sent by the first storage area, updating the order state to cancellation, and storing the data sent by the first storage area in the order data, wherein the former order state is ineffective;

sending a command to a bank terminal to change an account; and

feeding back a user order cancellation result.

In the aforementioned order cancellation processing method, if the user cancellation command is not received within the preset time period, the data in the first storage area are sent to the second storage area, and the order data in the first storage area are deleted.

In the aforementioned order cancellation processing method, the first storage area is a cache, and the second storage area is a database; or the first storage area and the second storage area are respectively located in different lists of the database; or the first storage area and the second storage area are respectively located in different areas of the same list of the database.

On another aspect, an order cancellation processing system is provided. The system includes a client and a business support platform connected with the client, wherein the business support platform includes:

a transceiver, used for receiving data sent by the client and sending data to the client;

a timer, used for calculating whether reaching a preset time beginning from the time that a user places an order;

an order data obtaining and processing unit, used for obtaining a user ordering command, analyzing and dividing order data obtained from the user, storing the order data in a first storage area and a second storage area respectively, and instructing the first storage area to send the order data stored therein to the second storage area if not receiving a user cancellation command within a preset time period;

a cancellation command obtaining and processing unit, used for obtaining the user cancellation command, judging whether the cancellation command is sent within the preset time period and whether the order is cancelable, if both yes, instructing the first storage area to update the data stored when placing the order, send the data to the second storage area and delete the data stored when placing the order, sending the user cancellation command to the second storage area, instructing the second storage area to update the order state to cancellation, and storing the data sent by the first storage area in the order data, wherein the former order state is ineffective;

a unit for notifying a bank to change an account, used for sending a command to a back terminal according to the instruction of the cancellation command obtaining and processing unit to change the account; and

a user feedback unit, used for feeding back a user order cancellation result according to the instruction of the cancellation command obtaining and processing unit and the account change condition of the bank fed back by the unit for notifying the bank to change the account.

In the aforementioned order cancellation processing system, the first storage area is a cache, and the second storage area is a database; or the first storage area and the second storage area are respectively located in different lists of the database; or the first storage area and the second storage area are respectively located in different areas of the same list of the database.

On still another aspect, a business support platform is provided. The system includes:

a transceiver, used for receiving data sent by a client and sending data to the client;

a timer, used for calculating whether reaching a preset time beginning from the time that a user places an order;

an order data obtaining and processing unit, used for obtaining a user ordering command, analyzing and dividing order data obtained from the user, storing the order data in a first storage area and a second storage area respectively, and instructing the first storage area to send the order data stored therein to the second storage area if not receiving a user cancellation command within a preset time period;

a cancellation command obtaining and processing unit, used for obtaining the user cancellation command, judging whether the cancellation command is sent within the preset time period and whether the order is cancelable, if both yes, instructing the first storage area to update the data stored when placing the order, send the data to the second storage area and delete the data stored when placing the order, sending the user cancellation command to the second storage area, instructing the second storage area to update the order state to cancellation, and storing the data sent by the first storage area in the order data, wherein the former order state is ineffective;

a unit for notifying a bank to change an account, used for sending a command to a bank terminal according to the instruction of the cancellation command obtaining and processing unit to change the account; and

a user feedback unit, used for feeding back a user order cancellation result according to the instruction of the cancellation command obtaining and processing unit and the account change condition of the bank fed back by the unit for notifying the bank to change the account.

In the aforementioned business support system, the first storage area is a cache, and the second storage area is a database; or the first storage area and the second storage area are respectively located in different lists of the database; or the first storage area and the second storage area are respectively located in different areas of the same list of the database.

The present disclosure further provides an order cancellation processing system, including a client (1) and a business support platform (2) connected with the client (1), wherein the business support platform (2) includes: a processor; and a memory for storing instructions executable by the processor; wherein the processor is configured to perform the following steps: receiving data sent by the client and sending data to the client; calculating whether reaching a preset time beginning from the time that a user places an order; obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period; obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective; sending a command to a back terminal to change the account; and feeding back a user order cancellation result, wherein the first storage area is a cache, and the second storage area is a database; or the first storage area and the second storage area are respectively located in different lists of the database; or the first storage area and the second storage area are respectively located in different areas of the same list of the database.

The present disclosure further provides a business support platform, including: a processor; and a memory for storing instructions executable by the processor; wherein the processor is configured to perform the following steps: receiving data sent by the client and sending data to the client; calculating whether reaching a preset time beginning from the time that a user places an order; obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period; obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective; sending a command to a back terminal to change the account; and feeding back a user order cancellation result, wherein the first storage area is a cache, and the second storage area is a database; or the first storage area and the second storage area are respectively located in different lists of the database; or the first storage area and the second storage area are respectively located in different areas of the same list of the database.

Compared with the prior art, the advantages of the technical solution of the present disclosure are mainly as follows:

In the present disclosure, by means of the existing database and cache storage manners, in an order management system, the orders are isolated in the interaction of modules, and meanwhile, the orders can be cancelled within 24 hours according to certain computational logic, so that a quick and convenient order cancellation flow is achieved. The technical solution of the present disclosure can be used for improving customer experience and shortening the waiting time of the customers, and no system loophole is generated, so that the customers can refund safely and quickly. Background operations can be simplified, orders within 24 hours are located at a cancelable state, and when the state is triggered, the operation is automatically carried out according to the logic without manual inspection, check or wait. By means of the solution, dirty data of the system can be reduced, only cancellation records are stored in the system with the assistance of a cancellation function, so as to avoid double records of refund and order cancellation. When analyzing the customer data subsequently, cancelled orders can be especially processed and especially analyzed, so that customer behaviors can be better mastered. On the premise of not breaking large order logic, the orders are rewritten in a new manner, and thus the orders can be cancelled completely and quickly.

### BRIEF DESCRIPTION OF THE DRAWINGS

FIG. 1 shows a practical example of a processing flow of an order cancellation processing system in one embodiment of the present disclosure when a customer places an order;

FIG. 2 shows a practical example of a processing flow of the order cancellation processing system in one embodiment of the present disclosure when the customer cancels the order;

FIG. 3 shows the order cancellation processing system in one embodiment of the present disclosure;

FIG. 4 shows a flowchart of the order cancellation processing method in one embodiment of the present disclosure.

### DESCRIPTION OF THE EMBODIMENTS

The technical solution of the present disclosure is based on differential utilization of a database storage and a cache, under the judgment of certain logic, orders placed by customers can be cancelled within 24 hours, and thus the problem of overlong refund time or order cancellation failure is avoided.

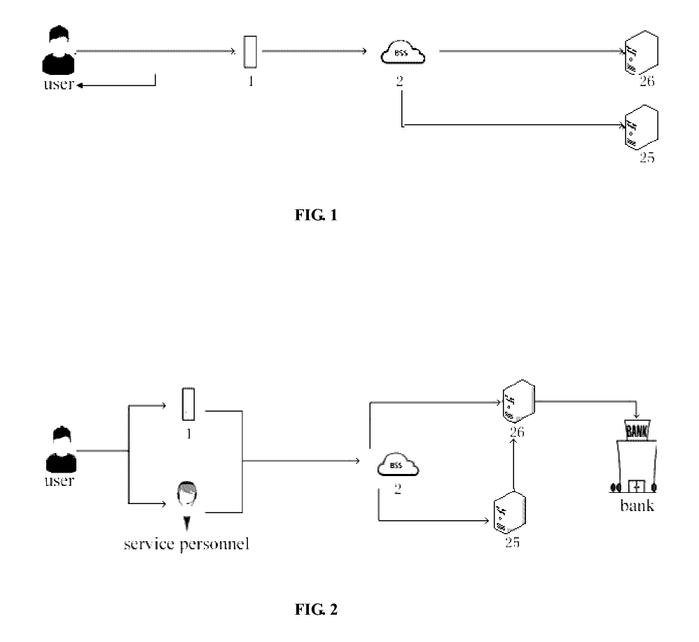

As shown in FIG. 1 and FIG. 2, the order cancellation processing system in one embodiment of the present disclosure includes a client 1 capable of placing an order and then logging in a business support platform (BSS) 2, and can be such portable devices as a mobile phone, a tablet computer or the like; and the business support platform (BSS) 2 includes a database used for storing order information and a mainframe.

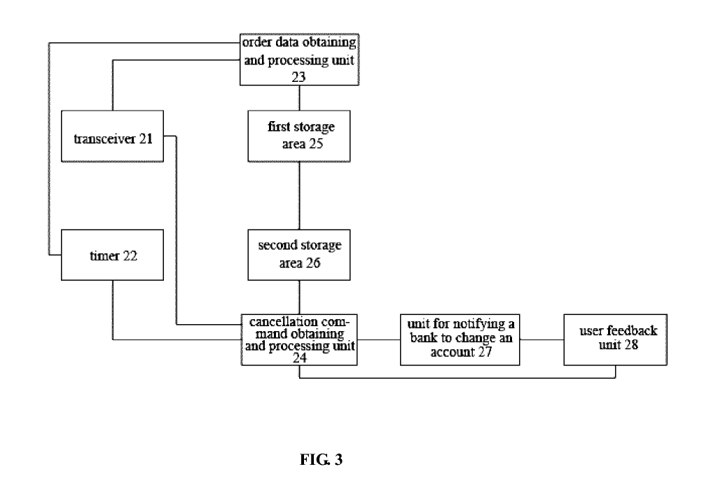

Specifically, as shown in FIG. 3, the business support platform 2 includes a transceiver 21, a timer 22, an order data obtaining and processing unit 23 connected with the transceiver 21 and the timer 22, a cancellation command obtaining and processing unit 24 connected with the transceiver 21 and the timer 22, a first storage area 25 and a second storage area 26, which are connected with the order data obtaining and processing unit 23 and the cancellation command obtaining and processing unit 24, a unit 27 for notifying a bank to change an account connected with the cancellation command obtaining and processing unit 24, and a user feedback unit 28 connected with the cancellation command obtaining and processing unit 24 and the unit 27 for notifying the bank to change the account, wherein the first storage area 25 is connected with the second storage area 26.

The transceiver 21 is used for receiving data sent by the client and sending data to the client; the timer 22 is used for calculating whether reaching a preset time beginning from the time that a user places an order; the order data obtaining and processing unit 23 is used for obtaining a user ordering command, analyzing and dividing order data obtained from the user, storing the order data in the first storage area 25 and the second storage area 26 respectively, and instructing the first storage area 25 to send the order data stored therein to the second storage area 26 if not receiving a user cancellation command within a preset time period; the cancellation command obtaining and processing unit 24 is used for obtaining the user cancellation command, judging whether the cancellation command is sent within the preset time period and whether the order is cancelable, if both yes, instructing the first storage area 25 to update the data stored when placing the order, send the data to the second storage area 26 and delete the data stored when placing the order, sending the user cancellation command to the second storage area 26, instructing the second storage area 26 to update the order state to cancellation, and storing the data sent by the first storage area 25 in the order data, wherein the former order state is ineffective; the unit 27 for notifying the bank to change the account is used for sending a command to a back terminal according to the instruction of the cancellation command obtaining and processing unit 24 to change the account; and the user feedback unit 28 is used for feeding back a user order cancellation result according to the instruction of the cancellation command obtaining and processing unit 24 and the account change condition of the bank fed back by the unit 27 for notifying the bank to change the account.

The implementation manners of the first storage area 25 and the second storage area 26 can be respectively in the cache and the database, or respectively in different lists of the database or different areas marked by special marks in the same list of the database.

In a preferred embodiment, the aforementioned preset time is 24 hours.

The customers place orders at the client for purchasing and cancel the orders through cancellation operations, after receiving the command, a background BSS system judges by checking the user transaction information and changes the data and states of storage and cache in the database and the mainframe, so as to quickly cancel the orders.

The order cancellation processing method in one embodiment of the present disclosure requires that a mobile phone terminal can be provided with an applicant client and the mobile phone terminal of the user is provided with the applicant client, and a BSS business support system platform needs to be established in advance: an app and a background mainframe are connected by a network, and the app terminal can issue a command to analyze and judge business and then send the business to the mainframe for storage and calculation. After being established, the platform immediately has the capacity of providing order cancellation in the present disclosure.

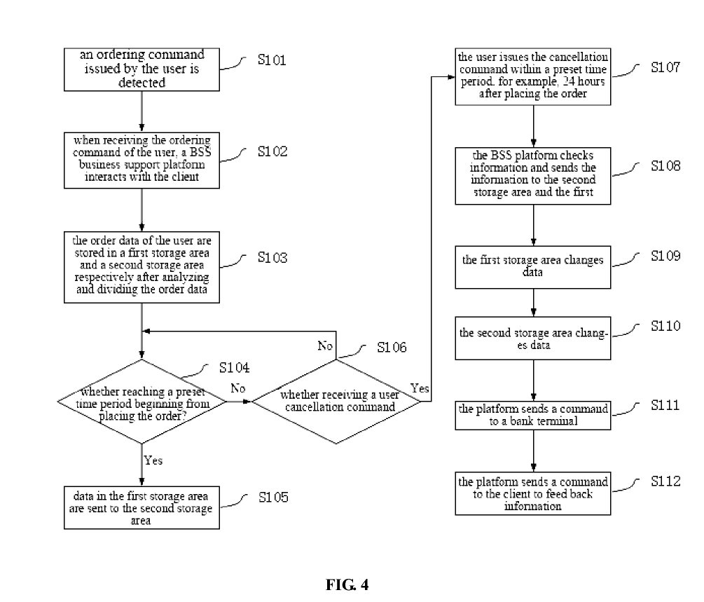

As shown in FIG. 4, the method includes the following steps:

Step S101, the BSS business support platform detects an ordering command issued by a user

A user side selects an order needing to be paid through the client and places an order to generate an ordering relation, and a platform side detects the ordering command of the user.

Step S102, when receiving the ordering command of the user, the BSS business support platform interacts with the client

The platform side receives the ordering command of the user, interacts with the client to upload ordering data to a cloud platform, and analyzes and processes the data uploaded by the user.

Step S103, the order data of the user are stored in the cache and the database respectively after analyzing and dividing the order data

After business calculation and analysis, the order data are divided into two parts and are respectively stores in the first storage area and the second storage area, ordering relation about to become effective of the user, payment information, used service information and the effective time of the order are stored in the first storage area and are not deleted within the preset time; order information of the user is stored in the second storage area, including order number, time and order state. Substantially, data needing to be deleted during cancellation in the order data are stored in the cache, and the data needing to be retained during cancellation in the order data are stored in the second storage area.

Step S104, timing is performed to check whether reaching the preset time period beginning from the time that the user places the order, if reaching the preset time period, step 105 proceeds; and if not reaching the preset time period, step S106 proceeds.

Step S105, if not receiving a user cancellation command within the preset time period, the first storage area is instructed to send the data stored therein to the second storage area

If not receiving the user cancellation command within the preset time period, for example, 24 hours, the BSS sends a command to the first storage area, after receiving the command, the first storage area sends the ordering relation, the payment information, the service information and the order state to the second storage area, and deletes the order data in the first storage area.

Step S106, whether receiving the user cancellation command is detected, if not, step S104 is returned, and if yes, step S107 proceeds.

Step S107, the user issues the cancellation command within a preset time period, for example, 24 hours after placing the order

The user carries out the cancellation operation due to such reasons as operation error or unwillingness for continuous use and the like, and initiates order cancellation to the cloud platform from the client or through service personnel.

Step S108, the BSS platform checks information and sends the information to the second storage area and the first storage area

The platform receives the cancellation command of the customer and analyzes the business, including whether the first storage area has data, whether the business is a cancelable service and whether the cancellation exceeds 24 hours, and if all is satisfied, sends the business to the second storage area and the first storage area for cancellation.

Step S109, the first storage area changes data

After receiving the command, the first storage area updates the ordering relation, the payment information, the service information and the order state, sends the same to the second storage area and the related platform for cancellation, and clears the order data in the first storage area.

Step S110, the second storage area changes data

After receiving the information of the platform and the first storage area, the second storage area inserts order state cancellation for the order data and updates the ordering relation, the payment information and the service information. The former order data state is ineffective.

Step S111, the platform sends a command to the bank terminal

After the second storage area changes the data, the platform sends the command to the bank terminal to change the account, and the order fees are returned to the bank in the same way.

Step S112, the platform sends a command to the client to feed back information

After all operations are completed, the platform terminal feeds back that the client has completed order cancellation.

The present disclosure further provides an order cancellation processing system, including a client (1) and a business support platform (2) connected with the client (1), wherein the business support platform (2) includes: a processor; and a memory for storing instructions executable by the processor; wherein the processor is configured to perform the following steps: receiving data sent by the client and sending data to the client; calculating whether reaching a preset time beginning from the time that a user places an order; obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period; obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective; sending a command to a back terminal to change the account; and feeding back a user order cancellation result, wherein the first storage area is a cache, and the second storage area is a database; or the first storage area and the second storage area are respectively located in different lists of the database; or the first storage area and the second storage area are respectively located in different areas of the same list of the database.

The present disclosure further provides a business support platform, including: a processor; and a memory for storing instructions executable by the processor; wherein the processor is configured to perform the following steps: receiving data sent by the client and sending data to the client; calculating whether reaching a preset time beginning from the time that a user places an order; obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period; obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective; sending a command to a back terminal to change the account; and feeding back a user order cancellation result, wherein the first storage area is a cache, and the second storage area is a database; or the first storage area and the second storage area are respectively located in different lists of the database; or the first storage area and the second storage area are respectively located in different areas of the same list of the database.

The order cancellation processing method in the above embodiment is merely an example listed for illustrating the technical solution of the present disclosure and is not limited to this specific implementation sequence, and actually, the implementation sequences of the steps can be changed according to demand.

The implementation manners of the first storage area and the second storage area can be respectively in the cache and the database, or respectively in different list of the database, or different areas marked by special marks in the same list of the database.

In summary, the order cancellation processing system and method provided by the present disclosure are used for solving the problems of slow order cancellation flow and complex mechanism, facilitating cancellation of the customers within 24 hours, and avoiding unnecessary costs of the customers, no additional manual judgment is needed, and meanwhile, the mechanism and solution can be used for greatly lowering the manpower cost and improving the customer experience to achieve the effects of quickly refunding and canceling orders for the customers.

What is claimed is:

1. An order cancellation processing method, comprising the following steps:
when receiving a user ordering command, analyzing and processing order data uploaded by a user, storing data needing to be deleted during cancellation in the order data in a first storage area, and storing data needing to be retained during cancellation in the order data in a second storage area;
if receiving a user cancellation command, judging whether the order is within a preset time period after placing the order and whether the order is cancelable, if both yes, updating, by the first storage area, the data stored when placing the order, sending the data to the second storage area and deleting the data stored when placing the order, and receiving, the second storage area, the user cancellation command and the data sent by the first storage area, updating the order state to cancellation, and storing the data sent by the first storage area in the order data, wherein the former order state is ineffective;
sending a command to a bank terminal to change an account; and
feeding back a user order cancellation result.

2. The order cancellation processing method of claim 1, wherein if the user cancellation command is not received within the preset time period, the data in the first storage area are sent to the second storage area, and the order data in the first storage area are deleted.

3. The order cancellation processing method of claim 1, wherein the first storage area is a cache, and the second storage area is a database; or the first storage area and the second storage area are respectively located in different lists of the database; or the first storage area and the second storage area are respectively located in different areas of the same list of the database.

4. An order cancellation processing system, comprising a client (1) and a business support platform (2) connected with the client (1), wherein the business support platform (2) comprises:
a processor; and
a memory for storing instructions executable by the processor;
wherein the processor is configured to perform the following steps:
receiving data sent by the client and sending data to the client;
calculating whether reaching a preset time beginning from the time that a user places an order;
obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period;
obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective;
sending a command to a back terminal to change the account; and
feeding back a user order cancellation result

5. The order cancellation processing system of claim 4, wherein the first storage area is a cache, and the second storage area is a database; or the first storage area and the second storage area are respectively located in different lists of the database; or the first storage area and the second storage area are respectively located in different areas of the same list of the database.

6. A business support platform, comprising:
a processor; and
a memory for storing instructions executable by the processor;
wherein the processor is configured to perform the following steps:
receiving data sent by the client and sending data to the client;
calculating whether reaching a preset time beginning from the time that a user places an order;
obtaining a user ordering command, analyzing and dividing order data obtained from the user, storing the order data in a first storage area (25) and a second storage area (26) respectively, and instructing the first storage area (25) to send the order data stored therein to the second storage area (26) if not receiving a user cancellation command within a preset time period;
obtaining the user cancellation command, judging whether the cancellation command is sent within the preset time period and whether the order is cancelable, if both yes, instructing the first storage area (25) to update the data stored when placing the order, send the data to the second storage area (26) and delete the data stored when placing the order, sending the user cancellation command to the second storage area (26), instructing the second storage area (26) to update the order state to cancellation, and storing the data sent by the first storage area (25) in the order data, wherein the former order state is ineffective;
sending a command to a back terminal to change the account; and
feeding back a user order cancellation result

7. The business support platform of claim 6, wherein the first storage area is a cache, and the second storage area is a database; or the first storage area and the second storage area are respectively located in different lists of the database; or the first storage area and the second storage area are respectively located in different areas of the same list of the database.
